(19) United States
(12) Patent Application Publication
(10) Pub. No.: US 2025/0174712 A1
(43) Pub. Date: May 29, 2025

(54) SULFUR DIOXIDE-BASED INORGANIC ELECTROLYTE SOLUTION DOPED WITH IODINE COMPOUND, METHOD OF MANUFACTURING THE SAME, ANODE INCLUDING THE SAME, METHOD OF MANUFACTURING ANODE, AND LITHIUM SECONDARY BATTERY INCLUDING ANODE

(71) Applicants: HYUNDAI MOTOR COMPANY, SEOUL (KR); KIA CORPORATION, SEOUL (KR); IUCF-HYU (INDUSTRY-UNIVERSITY COOPERATION FOUNDATION HANYANG UNIVERSITY), SEOUL (KR)

(72) Inventors: Kyu Ju Kwak, Hwaseong-si (KR); Ji Yong Lee, Seongnam-si (KR); Won Keun Kim, Seoul (KR); Eun Ji Kwon, Yongin-si (KR); Samuel Seo, Suwon-si (KR); Yeon Jong Oh, Seoul (KR); Dong Hyun Lee, Seoul (KR); Sang Su Lee, Suwon-si (KR); Kyoung Han Ryu, Yongin-si (KR); Ji Ho Lim, Seoul (KR); Han Su Kim, Seoul (KR); Ji Whan Lee, Seoul (KR); Seong Hoon Choi, Seoul (KR); Seung Do Mun, Seoul (KR)

(73) Assignees: HYUNDAI MOTOR COMPANY, SEOUL (KR); KIA CORPORATION, SEOUL (KR); IUCF-HYU (INDUSTRY-UNIVERSITY COOPERATION FOUNDATION HANYANG UNIVERSITY), SEOUL (KR)

(21) Appl. No.: 18/659,399

(22) Filed: May 9, 2024

(30) Foreign Application Priority Data
Nov. 23, 2023 (KR) 10-2023-0164689

(51) Int. Cl. H01M 10/0562; H01M 4/02; H01M 4/04; H01M 4/38; H01M 10/052

(52) U.S. Cl. CPC H01M 10/0562; H01M 4/0407; H01M 4/382; H01M 10/052; H01M 2004/027; H01M 2300/0071; H01M 2300/008

(57) ABSTRACT

A sulfur dioxide-based inorganic electrolyte solution is doped with an iodine compound. A method of manufacturing the inorganic electrolyte solution includes preparing a powder salt by mixing a metal chloride, aluminum chloride and an iodine compound, and synthesizing the inorganic electrolyte solution by injecting sulfur dioxide (SO₂) gas into the powder salt. The inorganic electrolyte solution is represented by Chemical Formula 1: M·(AlCl₍₄₋ₓ₎Iₓ)_{z}·ySO₂, where M is at least one selected from the group consisting of Li, Na, K, Ca, and Mg, 0<x≤1, 0<y≤6, and 1≤z≤2. Reliability and stability of the battery are improved by suppressing growth of dendrites and reducing overvoltage occurring during charging and discharging of the battery by performing pre-treatment of lithium metal using the inorganic electrolyte solution.

### CROSS REFERENCE TO RELATED APPLICATIONS

This application claims under 35 U.S.C. § 119(a) the benefit of priority to Korean Patent Application No. 10-2023-0164689 filed on Nov. 23, 2023, the entire contents of which are incorporated herein by reference.

### BACKGROUND

### (a) Technical Field

The present disclosure relates to a sulfur dioxide-based inorganic electrolyte solution doped with an iodine compound, a method of manufacturing the same, an anode including the same, a method of manufacturing the anode, and a lithium secondary battery including the anode, in which reliability and stability of the battery may be improved by suppressing growth of dendrites and reducing overvoltage occurring during charging and discharging of the battery by performing pre-treatment of lithium metal using the inorganic electrolyte solution.

### (b) Background Art

Secondary batteries which are rechargeable are used not only in small electronic devices, such as mobile phones and notebook computers, but also in large means of transportation, such as hybrid vehicles and electric vehicles. Accordingly, demand for high-capacity secondary batteries is growing. Graphite, conventionally used as an anode material, is inexpensive to produce and has a relatively large capacity, but causes volume expansion during a charging and discharging process, which leads to structural changes in secondary batteries and reduction in stability.

In contrast, lithium metal has a high theoretical capacity and a very low oxidation-reduction potential, and is thus attracting attention as an anode material for lithium secondary batteries with a high capacity and a high energy density. In general, an organic electrolytic solution including a lithium salt and an organic solvent is used as an electrolyte solution for lithium secondary batteries, but the organic electrolytic solution is highly flammable, and thus use of the organic electrolytic solution may cause serious problems in safety when operating a battery.

In order to improve these problems, use of inorganic electrolyte solutions (liquid electrolytes) is proposed. Particularly, an inorganic liquid electrolyte including LiAlCl₄ and SO₂ is recently receiving a lot of attention because it has nonflammability and high ionic conductivity, but the inorganic liquid electrolyte has high reactivity with lithium metal, and thus causes problems, such as growth of dendrites, due to precipitation of LiCl on the surface of lithium metal.

The above information disclosed in this Background section is only for enhancement of understanding of the background of the disclosure and therefore it may contain information that does not form the prior art that is already known in this country to a person of ordinary skill in the art.

### SUMMARY

The present disclosure has been made in an effort to solve the above-described problems associated with the prior art, and it is an object of the present disclosure to a sulfur dioxide-based inorganic electrolyte solution doped with an iodine compound and a method of manufacturing the same, in which growth of dendrites on the surface of lithium metal caused by reaction of a conventional sulfur dioxide-based inorganic electrolyte solution with lithium metal is suppressed and reliability and stability of the inorganic electrolyte solution are improved.

In particular, growth of dendrites on the surface of lithium metal is suppressed and reliability and stability of the inorganic electrolyte solution are improved using lithium metal pre-treated with the inorganic electrolyte solution as an anode.

The objects to be accomplished by the present disclosure are not limited to the above-mentioned objects. The objects to be accomplished by the present disclosure will become apparent from the following description, and will be implemented by means described in the claims and combinations thereof.

In one aspect, the present disclosure provides an inorganic electrolyte solution represented by following Chemical Formula 1.

M·(AlCl₍₄₋ₓ₎Iₓ)_{z}·ySO₂ Chemical Formula 1:

Here, M is at least one selected from the group consisting of Li, Na, K, Ca, and Mg, 0<x≤1, 0<y≤6, and 1≤z≤2.

In a preferred embodiment, the inorganic electrolyte solution may be expressed as Li·(AlCl₍₄₋ₓ₎Iₓ)·ySO₂. Otherwise, the inorganic electrolyte solution may be expressed as Na·(AlCl₍₄₋ₓ₎Iₓ)·ySO₂. Here, 0<x≤1 and 0<y≤6.

In another aspect, the present disclosure provides a method of manufacturing an inorganic electrolyte solution including preparing a powder salt by mixing a metal chloride, aluminum chloride and an iodine compound, and synthesizing the inorganic electrolyte solution by injecting sulfur dioxide (SO₂) gas into the powder salt, wherein the inorganic electrolyte solution is represented by following Chemical Formula 1.

M·(AlCl₍₄₋ₓ₎Iₓ)_{z}·ySO₂ Chemical Formula 1:

Here, M is at least one selected from the group consisting of Li, Na, K, Ca, and Mg, 0<x≤1, 0<y≤6, and 1≤z≤2.

In a preferred embodiment, the metal chloride may include at least one selected from the group consisting of lithium chloride (LiCl), sodium chloride (NaCl), potassium chloride (KCl), calcium chloride (CaCl₂), magnesium chloride (MgCl₂), and combinations thereof.

In another preferred embodiment, the iodine compound may include at least one selected from the group consisting of lithium iodide (LiI), sodium iodide (NaI), potassium iodide (KI), calcium iodide (CaI₂), magnesium iodide (MgI₂), and combinations thereof.

In still another preferred embodiment, an amount of the iodine compound may be 11 mol % or less with respect to an amount of the metal chloride.

In yet another preferred embodiment, a metal included in the iodine compound and a metal included in the metal chloride may be the same.

In still yet another preferred embodiment, the iodine compound and the metal chloride may be mixed in a molar ratio of 1:3-100. In a further preferred embodiment, the iodine compound and the metal chloride may be mixed in a molar ratio of 1:8-10.

In still another aspect, the present disclosure provides a method of manufacturing an anode for lithium secondary batteries including preparing an inorganic electrolyte solution represented by following Chemical Formula 1, and forming an inorganic electrolyte layer on lithium metal by impregnating the lithium metal with the inorganic electrolyte solution.

M·(AlCl₍₄₋ₓ₎Iₓ)_{z}·ySO₂ Chemical Formula 1:

Here, M is at least one selected from the group consisting of Li, Na, K, Ca, and Mg, 0<x≤1, 0<y≤6, and 1≤z≤2.

In a preferred embodiment, the inorganic electrolyte layer may include at least one selected from the group consisting of LiCl, a lithium sulfur-oxy compound (LiₓS_{y}O_{z}), Li₂S, Li₂O, and combinations thereof.

In yet another aspect, the present disclosure provides an anode including lithium metal, and an inorganic electrolyte layer located on the lithium metal, wherein the inorganic electrolyte layer includes at least one selected from the group consisting of LiCl, a lithium sulfur-oxy compound (LiₓS_{y}O_{z}), Li₂S, Li₂O, and combinations thereof.

In still yet another aspect, the present disclosure provides a lithium secondary battery including a cathode, the above-described anode, a separator located between the cathode and the anode, and an electrolyte impregnated into at least some of the cathode, the anode, or the separator, wherein the anode further includes a solid electrolyte interface (SEI) layer located on the inorganic electrolyte layer, and the SEI layer is formed in a formation process.

In a preferred embodiment, the SEI layer may not include iodine (I).

In another preferred embodiment, as depth profiling results obtained by XPS analysis of Li 1s in the SEI layer, contents of lithium oxide (Li₂O) and lithium chloride (LiCl) may be increased as a depth from a surface of the SEI layer towards the inorganic electrolyte layer increases.

In still another preferred embodiment, as depth profiling results obtained by XPS analysis of S 2p in the SEI layer, a content of lithium sulfide (Li₂S) may be increased as a depth from a surface of the SEI layer towards the inorganic electrolyte layer increases.

In yet another preferred embodiment, peaks due to lithium sulfide (Li₂S) having the increased content may be observed at a binding energy range of 158 eV to 162 eV.

Other aspects and preferred embodiments of the disclosure are discussed infra.

### BRIEF DESCRIPTION OF THE FIGURES

The above and other features of the present disclosure will now be described in detail with reference to certain exemplary embodiments thereof illustrated in the accompanying drawings which are given hereinbelow by way of illustration only, and thus are not limitative of the present disclosure, and wherein:

FIG. 1 is a schematic cross-sectional view of a secondary battery according to the present disclosure;

FIG. 2 is view illustrating a process of impregnating lithium metal with an organic electrolyte solution according to the present disclosure;

FIG. 3 shows Raman spectroscopy analysis results of an inorganic electrolyte solution according to Manufacturing Example 1;

FIG. 4 shows Raman spectroscopy analysis results of an inorganic electrolyte solution according to Manufacturing Example 2;

FIG. 5 shows Raman spectroscopy analysis results of an inorganic electrolyte solution according to Comparative Manufacturing Example 1;

FIG. 6 shows Raman spectroscopy analysis results of inorganic electrolyte solutions manufactured by changing a ratio of a metal chloride to an iodine compound;

FIG. 7 shows electrochemical evaluation results of secondary batteries manufactured according to Examples and Comparative Example;

FIG. 8 is a graph representing the results shown in FIG. 7 in an integrated way;

FIG. 9 shows impedance spectroscopy analysis results of lithium metal and an SEI layer of the secondary battery manufactured according to Example 1;

FIG. 10 shows impedance spectroscopy analysis results of lithium metal and an SEI layer of the secondary battery manufactured according to Comparative Example 1;

FIG. 11 is an image of the cross-section of the lithium metal of the secondary battery manufactured according to Example 1 photographed with a scanning electron microscope (SEM);

FIG. 12 is an image of the cross-section of the lithium metal of the secondary battery manufactured according to Comparative Example 1 photographed with the SEM;

FIG. 13 shows XPS analysis results of Li 1s in the lithium metal and the SEI layer of the secondary battery manufactured according to Example 1 after charging and discharging for 50 cycles;

FIG. 14 shows XPS analysis results of S 2p in the lithium metal and the SEI layer of the secondary battery manufactured according to Example 1 after charging and discharging for 50 cycles;

FIG. 15 shows XPS analysis results of I 3d in the lithium metal and the SEI layer of the secondary battery manufactured according to Example 1 after charging and discharging for 50 cycles;

FIG. 16 shows XPS analysis results of Li 1s in the lithium metal and the SEI layer of the secondary battery manufactured according to Comparative Example 1 after charging and discharging for 50 cycles; and

FIG. 17 shows XPS analysis results of S 2p in the lithium metal and the SEI layer of the secondary battery manufactured according to Comparative Example 1 after charging and discharging for 50 cycles.

It should be understood that the appended drawings are not necessarily to scale, presenting a somewhat simplified representation of various preferred features illustrative of the basic principles of the disclosure. The specific design features of the present disclosure as disclosed herein, including, for example, specific dimensions, orientations, locations, and shapes, will be determined in part by the particular intended application and use environment.

In the figures, reference numbers refer to the same or equivalent parts of the present disclosure throughout the several figures of the drawing.

### DETAILED DESCRIPTION

The above-described objects, other objects, advantages and features of the present disclosure will become apparent from the descriptions of embodiments given hereinbelow with reference to the accompanying drawings. However, the present disclosure is not limited to the embodiments disclosed herein and may be implemented in various different forms. The embodiments are provided to make the description of the present disclosure thorough and to fully convey the scope of the present disclosure to those skilled in the art.

In the following description of the embodiments, terms, such as “including”, “comprising” and “having”, are to be interpreted as indicating the presence of characteristics, numbers, steps, operations, elements or parts stated in the description or combinations thereof, and do not exclude the presence of one or more other characteristics, numbers, steps, operations, elements, parts or combinations thereof, or possibility of adding the same. In addition, it will be understood that, when a part, such as a layer, a film, a region or a plate, is said to be “on” another part, the part may be located “directly on” the other part or other parts may be interposed between the two parts. In the same manner, it will be understood that, when a part, such as a layer, a film, a region or a plate, is said to be “under” another part, the part may be located “directly under” the other part or other parts may be interposed between the two parts.

All numbers, values and/or expressions representing amounts of components, reaction conditions, polymer compositions and blends used in the description are approximations in which various uncertainties in measurement generated when these values are obtained from essentially different things are reflected and thus it will be understood that they are modified by the term “about”, unless stated otherwise. In addition, it will be understood that, if a numerical range is disclosed in the description, such a range includes all continuous values from a minimum value to a maximum value of the range, unless stated otherwise. Further, if such a range refers to integers, the range includes all integers from a minimum integer to a maximum integer, unless stated otherwise.

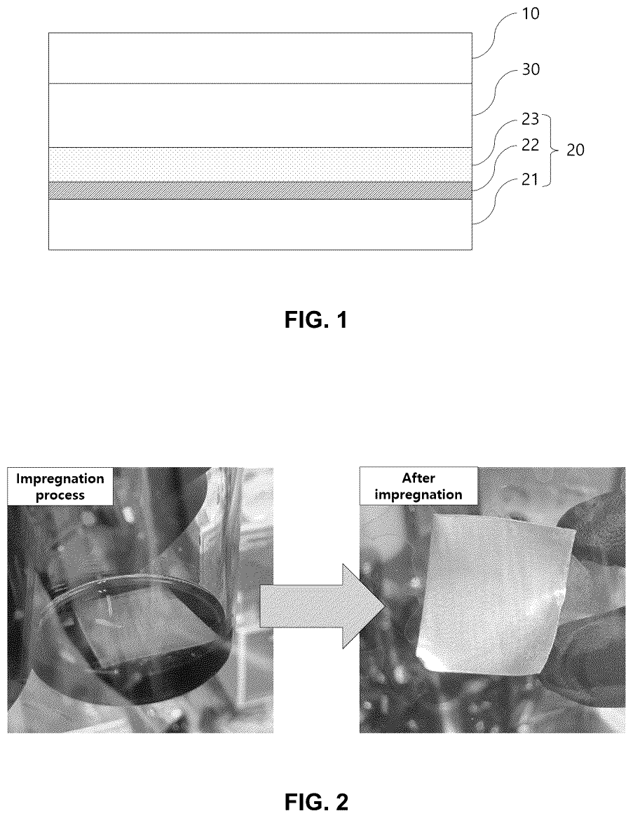

Before explaining the present disclosure, a secondary battery according to one embodiment of the present disclosure will be described as a lithium secondary battery, but is not limited thereto. FIG. 1 is a schematic cross-sectional view of a secondary battery according to the present disclosure. Referring to FIG. 1, the secondary battery may include a cathode 10, an anode 20, and a separator 30 located between the cathode 10 and the anode 20.

Here, the anode 20 may include an anode current collector and an anode active material located on the anode current collector. Further, the anode 20 may include lithium metal 21, an inorganic electrolyte layer 22, and a solid electrolyte interface (SEI) layer 23. The SEI layer 23 may be formed after a formation process for the secondary battery. Further, although not separately shown, the secondary battery may be impregnated with an electrolyte solution.

According to one aspect of the present disclosure, an inorganic electrolyte solution represented by following Chemical Formula 1 is provided.

M·(AlCl₍₄₋ₓ₎Iₓ)_{z}·ySO₂ Chemical Formula 1:

(here, M is at least one selected from the group consisting of Li, Na, K, Ca, and Mg, 0<x≤1, 0<y≤6, and 1≤z≤2).

For example, the inorganic electrolyte solution may be expressed as Li·(AlCl₍₄₋ₓ₎Iₓ)·ySO₂. Otherwise, the inorganic electrolyte solution may be expressed as Na·(AlCl₍₄₋ₓ₎Iₓ)·ySO₂ (here, 0<x≤1 and 0<y≤6). x indicating the content of iodine in the inorganic electrolyte solution may be changed depending on the content of an iodine compound added in a manufacturing process of the inorganic electrolyte solution.

The inorganic electrolyte solution may be a sulfur dioxide-based inorganic electrolyte solution doped with iodine, and may have nonflammability and high ionic conductivity compared to conventional organic electrolyte solutions. The inorganic electrolyte solution may be used to impregnate the lithium metal 21 therewith so that the inorganic electrolyte layer 22 is formed on the surface of the lithium metal 21 so as to modify the surface of the lithium metal 21, or may serve as an electrolyte solution used to impregnate the secondary battery therewith. Preferably, the inorganic electrolyte solution may be used to impregnate the lithium metal 21 therewith so as to modify the surface of the lithium metal 21.

According to another aspect of the present disclosure, there is provided a method of manufacturing an inorganic electrolyte solution including preparing a powder salt by mixing a metal chloride, aluminum chloride and an iodine compound, and synthesizing an inorganic electrolyte solution by injecting sulfur dioxide (SO₂) gas into the powder salt, and the inorganic electrolyte solution is represented by following Chemical Formula 1.

M·(AlCl₍₄₋ₓ₎Iₓ)_{z}·ySO₂ Chemical Formula 1:

(here, M is at least one selected from the group consisting of Li, Na, K, Ca, and Mg, 0<x≤1, 0<y≤6, and 1≤z≤2).

In one embodiment, the metal chloride may include one selected from the group consisting of lithium chloride (LiCl), sodium chloride (NaCl), potassium chloride (KCl), calcium chloride (CaCl₂), magnesium chloride (MgCl₂), and combinations thereof.

Further, the iodine compound may include one selected from the group consisting of lithium iodide (LiI), sodium iodide (NaI), potassium iodide (KI), calcium iodide (CaI₂), magnesium iodide (MgI₂), and combinations thereof.

In preparing the powder salt, the iodine compound and the metal chloride may be mixed in a molar ratio of 1:3 to 1:100, and preferably the iodine compound and the metal chloride may be mixed in a molar ratio of 1:8 to 1:10. When analyzing contents of respective components in the inorganic electrolyte solution synthesized using the powder salt, the amount of the iodine compound may be 11 mol % or less with respect to the amount of the metal chloride.

When the molar ratio of the iodine compound to the metal chloride exceeds 1:100, the amount of the iodine compound is too small to achieve an effect of modifying the surface of the lithium metal 21, desired by the present disclosure. When the molar ratio of the iodine compound to the metal chloride is less than 1:3, an excessively large amount of the iodine compound is added and thus economic efficiency may be reduced. Further, electrochemical properties of the lithium metal 21 may be particularly improved by the inorganic electrolyte solution when the iodine compound and the metal chloride are mixed in a molar ratio of 1:8 to 1:10.

In one embodiment, a metal included in the iodine compound and a metal included in the metal chloride may be the same. For example, when lithium chloride (LiCl) is used as the metal chloride, lithium iodide (LiI) may be used as the iodine compound. Further, when sodium chloride (NaCl) is used as the metal chloride, sodium iodide (NaI) may be used as the iodine compound. In this way, by setting the same metal in the iodine compound and the metal chloride, the inorganic electrolyte solution may be more easily doped with iodine.

After preparing the powder salt, a sulfur dioxide-based inorganic electrolyte solution having iodine (I₂) dissolved therein or doped with iodine (I₂) may be obtained by reacting the powder salt with sulfur dioxide (SO₂) gas. Here, by performing stirring in the process of synthesizing the inorganic electrolyte solution, it is possible to shorten a synthesis time and to synthesize an inorganic electrolyte having superior quality.

According to yet another aspect of the present disclosure, there is provided a method of manufacturing an anode for lithium secondary batteries including preparing an inorganic electrolyte solution represented by following Chemical Formula 1, and forming an inorganic electrolyte layer on lithium metal by impregnating the lithium metal with the inorganic electrolyte solution.

M·(AlCl₍₄₋ₓ₎Iₓ)_{z}·ySO₂ Chemical Formula 1:

(here, M is at least one selected from the group consisting of Li, Na, K, Ca, and Mg, 0<x≤1, 0<y≤6, and 1≤z≤2).

When the lithium metal 21 is impregnated with the sulfur dioxide-based inorganic electrolyte solution doped with iodine, the inorganic electrolyte layer 22 derived from the inorganic electrolyte solution may be formed on the surface of the lithium metal 21 while modifying the surface of the lithium metal 21. The impregnation process may be performed for 3 minutes to 48 hours, preferably for 60 minutes to 24 hours. When the impregnation process is performed for less than 3 minutes, it is difficult to form the inorganic electrolyte layer 22 having a sufficient thickness, and when the impregnation process is performed for more than 48 hours, efficiency of the process may be reduced.

Further, treatment configured to assist modification of the surface of the lithium metal 21 and formation of the inorganic electrolyte layer 22 thereon, for example, electrical treatment, may be performed during the impregnation process.

The inorganic electrolyte layer 22 formed on the surface of the lithium metal 21 may suppress growth of dendrites on the surface of the lithium metal 21 during the process of charging and discharging a secondary battery using an anode 20 including the lithium metal 21, and may induce formation of an SEI layer 23 having high ionic conductivity so as to assist formation of a more uniform and thinner SEI layer 23. That is, the inorganic electrolyte layer 22 may serve as a seed for formation of the SEI layer 23.

In one embodiment, the inorganic electrolyte layer 22 may include one selected from the group consisting of LiCl, a lithium sulfur-oxy compound (LiₓS_{y}O_{z}, 1≤x≤3, 0<y≤2, and 1≤z≤10) Li₂S, Li₂O, and combinations thereof. The composition of the inorganic electrolyte layer 22 and the contents of respective components of inorganic electrolyte layer 22 may be influenced by the composition of the inorganic electrolyte solution. Concretely, when the inorganic electrolyte solution is doped with iodine, the contents of Li₂S and Li₂O included in the inorganic electrolyte layer 22 may be increased, compared to a case in which the inorganic electrolyte solution is not doped with iodine.

In one embodiment, the anode 20 manufactured by the above method may be provided. The anode 20 may include the lithium metal 21 and the inorganic electrolyte layer 22 formed on the lithium metal 21, and the lithium metal 21 may be a lithium metal alloy. The lithium metal alloy may include lithium and a metal or a metalloid which is alloyable with lithium. The metal or the metalloid which is alloyable with lithium may include Si, Sn, Al, Ge, Pb, Bi, Sb, or the like. The lithium metal has a large electrical capacity per unit weight, and is thus advantageous for implementation of high capacity batteries.

According to still another aspect of the present disclosure, there is provided a lithium secondary battery including a cathode 10, an anode 20, a separator 30 located between the cathode 10 and the anode 20, and an electrolyte impregnated into at least some of the cathode 10, the anode 20 or the separator 30, the anode 20 includes a solid electrolyte interface (SEI) layer 23 located on an inorganic electrolyte layer 22, and the SEI layer 23 is formed in the formation process.

The cathode 10 may include a cathode current collector, a cathode active material, a binder, a conductive material, and the like. The cathode current collector may include a plate-shaped substrate having electrical conductivity. The cathode current collector may include aluminum foil. The thickness of the cathode current collector is not particularly limited and may be, for example, 1 μm to 500 μm.

The cathode active material may be an oxide active material or a sulfide active material.

The oxide active material may be a rocksalt layer-type active material, such as LiCoO₂, LiMnO₂, LiNiO₂, LiVO₂ or Li₁₊ₓNi_{1/3}Co_{1/3}Mn_{1/3}O₂, a spinel-type active material, such as LiMn₂O₄ or Li(Ni_{0.5}Mn_{1.5})O₄, an inverted spinel-type active material, such as LiNiVO₄ or LiCoVO₄, an olivine-type active material, such as LiFePO₄, LiMnPO₄, LiCoPO₄ or LiNiPO₄, a silicon-containing active material, such as Li₂FeSiO₄ or Li₂MnSiO₄, a rocksalt layer-type active material in which a part of a transition metal is substituted with a different kind of metal, such as LiNi_{0.8}Co_{(0.2-x)}AlₓO₂ (0<x<0.2), a spinel-type active material in which a part of a transition metal is substituted with a different kind of metal, such as Li₁₊ₓMn_{2-x-y}M_{y}O₄ (M is at least one of Al, Mg, Co, Fe, Ni or Zn, and 0<x+y<2), or lithium titanate, such as Li₄Ti₅O₁₂.

The sulfide active material may be copper Chevrel, iron sulfide, cobalt sulfide, nickel sulfide, or the like. However, the cathode active material is not limited to these materials, and any cathode active material which is available in the field in the art may be used.

The binder is a component which assists bonding between the cathode active material and the conductive material and bonding of the cathode active material and the conductive material to the cathode current collector, and may include polyvinylidene fluoride, polyvinyl alcohol, carboxymethyl cellulose (CMC), starch, hydroxypropyl cellulose, regenerated cellulose, polyvinylpyrrolidone, tetrafluoroethylene, polyethylene, polypropylene, ethylene-propylene-diene terpolymer (EPDM), sulfonated EPDM, styrene butadiene rubber, fluoro rubber, various copolymers, or the like.

The conductive material is not particularly limited, as long as it causes no chemical change in the corresponding battery and has conductivity, and may include, for example, graphite, such as natural graphite or artificial graphite, a carbon-based material, such as carbon black, acetylene black, Ketjen black, channel black, furnace black, lamp black or thermal black, conductive fibers, such as carbon fibers or metallic fibers, metal powder, such as carbon fluoride, aluminum or nickel powder, a conductive metal oxide, such as zinc oxide or titanium oxide, a conductive material, such as a polyphenylene derivative, or the like.

The SEI layer 23 is formed at the beginning of charging, prevents reaction of lithium ions with a lithium anode or other materials during the charging and discharging process, and acts as an ion tunnel to allow only lithium ions to pass therethrough. Therefore, the SEI layer 23 selectively passes only lithium ions and serves to block direct contact between the electrolyte solution and the lithium anode having high reactivity.

Therefore, when the SEI layer 23 is formed unevenly, supply of lithium ions becomes unstable, and thus, lithium dendrites grow on the surface of the lithium metal 21. Further, non-uniform electrodeposition of lithium ions continuously causes side reactions between the lithium metal 21 and the electrolyte, and thereby, the SEI layer 23 may be thickened and depletion of the electrolyte may be caused.

Here, the formation process is a process of activating an assembled secondary battery to have electrical characteristics. Specifically, the formation process sequentially goes through formation, aging, and internal resistance/open circuit voltage (IR/OCV) testing, and is a process of activating the secondary battery and selecting defective cells through charging and discharging, and aging of the battery. In the formation step, the secondary battery in a discharged state is charged so as to be activated. In the aging step, the secondary battery is stored at a predetermined temperature or humidity for a designated time so that an electrolyte solution is sufficiently dispersed in the secondary battery so as to create the state of being optimized for migration of ions.

The SEI layer 23 is located on the inorganic electrolyte layer 22, and the average thickness of the SEI layer 23 may be 3 μm to 90 μm, preferably 3 μm to 50 μm, and more preferably 3 μm to 25 μm. When the average thickness of the SEI layer 23 exceeds 90 μm, the SEI layer 23 acts as a resistance which interferes with conduction of lithium ions during the charging and discharging process, and an excessively large amount of lithium is consumed in a process of forming the SEI layer 23 and may thus reduce the energy density of the secondary battery.

When the average thickness of the SEI layer 23 is 3 μm to 25 μm, the SEI layer 23 may serve as a stable ion transfer medium at a high current without interfering with conduction of lithium ions.

Meanwhile, the SEI layer 23 is grown using the inorganic electrolyte layer 22 as a seed during the charging and discharging process of the secondary battery, and may have substantially the same composition as that of the inorganic electrolyte layer 22. Therefore, when the anode 20 including the inorganic electrolyte layer 22 and the SEI layer 23 is photographed with a scanning electron microscope (SEM), the inorganic electrolyte layer 22 distinguished from the SEI layer 23 may not be observed. That is, the average thickness of the SEI layer 23 indicates the thickness of the SEI layer 23 including the inorganic electrolyte layer 22, not the thickness of a separate SEI layer distinguished from the inorganic electrolyte layer 22.

In addition, the SEI layer 23 may not include an iodine (I)-related component. When iodine is included in the SEI layer 23, the resistance and reactivity of the SEI layer 23 are increased, and thereby, growth of dendrites and growth of the SEI layer 23 may be promoted during the charging and discharging process.

Hereinafter, the present disclosure will be described in more detail through the following Examples and Comparative Examples. The following Examples and Comparative Examples serve merely to exemplarily describe the present disclosure, and are not intended to limit the scope and spirit of the disclosure.

### Manufacture of Inorganic Electrolyte Solution

Powders were prepared so that metal chloride, an iodine compound and aluminum chloride (AlCl₃) were mixed in molar ratios as set forth in Table 1 below.

TABLE 1

| | | Comp. | | | Comp. |
|---|---|---|---|---|---|
| | Manufacturing | Manufacturing | | Manufacturing | Manufacturing |
| Composition | example 1 | example 1 | Composition | example 2 | example 2 |
| LiCl | 0.9 | 1 | NaCl | 0.9 | 1 |
| LiI | 0.1 | — | NaI | 0.1 | — |
| AlCl₃ | 1 | 1 | AlCl₃ | 1 | 1 |

### Manufacturing Example 1

Powder salt was prepared by mixing 11 mol % of lithium iodide (LiI) powder with respect to the amount of lithium chloride (LiCl) powder and 111 mol % of aluminum chloride (AlCl₃) powder with respect to the amount of lithium chloride (LiCl) powder.

A sulfur dioxide (SO₂)-based inorganic electrolyte solution doped with iodine (I) was synthesized by injecting sulfur dioxide (SO₂) gas into the powder salt, and the synthesized sulfur dioxide (SO₂)-based inorganic electrolyte solution is represented by following Chemical Formula 2.

LiAlCl_{3.9}I_{0.1}·ySO₂ Chemical Formula 2:
(here, y is a number from 0 to 6).

### Manufacturing Example 2

Powder salt was prepared by mixing 11 mol % of sodium iodide (NaI) powder with respect to the amount of sodium chloride (NaCl) powder and 111 mol % of aluminum chloride (AlCl₃) powder with respect to the amount of sodium chloride (NaCl) powder.

A sulfur dioxide (SO₂)-based inorganic electrolyte solution doped with iodine (I) was synthesized by injecting sulfur dioxide (SO₂) gas into the powder salt, and the synthesized sulfur dioxide (SO₂)-based inorganic electrolyte solution is represented by following Chemical Formula 3.

NaAlCl_{3.9}I_{0.1}·ySO₂ Chemical Formula 3:
(here, y is a number from 0 to 6).

### Comparative Manufacturing Example 1

Powder salt was prepared by mixing lithium chloride (LiCl) powder and aluminum chloride (AlCl₃) powder at the same mol %.

A sulfur dioxide (SO₂)-based inorganic electrolyte solution doped with no iodine (I) was synthesized by injecting sulfur dioxide (SO₂) gas into the powder salt, and the synthesized sulfur dioxide (SO₂)-based inorganic electrolyte solution is represented by following Chemical Formula 4.

LiAlCl₄·3SO₂ Chemical Formula 4:

### Comparative Manufacturing Example 2

Powder salt was prepared by mixing sodium chloride (NaCl) powder and aluminum chloride (AlCl₃) powder at the same mol %, a sulfur dioxide (SO₂)-based inorganic electrolyte solution doped with no iodine (I) was synthesized by injecting sulfur dioxide (SO₂) gas into the powder salt, and the synthesized sulfur dioxide (SO₂)-based inorganic electrolyte solution is represented by following Chemical Formula 5.

NaAlCl₄·2SO₂ Chemical Formula 5:

### Manufacture of Anode

### Example 1

A process of impregnating lithium metal with the inorganic electrolyte solution according to Manufacturing Example 1 is shown in FIG. 2. Specifically, a beaker filled with the inorganic electrolyte solution according to Manufacturing Example 1 and a thin film formed of lithium metal with a thickness of 200 μm were prepared. After the lithium metal thin film was put into the beaker, the lithium metal thin film was impregnated with the inorganic electrolyte solution at a temperature of 25° C. and 1 atm for 24 hours. Referring to FIG. 2, it was confirmed that a white inorganic electrolyte layer was formed on the surface of the lithium metal thin film.

### Example 2

A lithium metal thin film having an inorganic electrolyte layer formed on the surface thereof was obtained by the same process as in Example 2, except that a lithium metal thin film was impregnated with the inorganic electrolyte solution according to Manufacturing Example 2.

### Comparative Example 1

For contrast with Examples in which the lithium metal thin films were impregnated with the corresponding sulfur dioxide-based inorganic electrolyte solutions doped with iodine, a lithium metal thin film prepared without a separate impregnation process was used as is.

### Manufacture of Lithium Secondary Batteries

In order to evaluate performances of the lithium metal thin films having the inorganic electrolyte layers manufactured according to Examples and Comparative Example, lithium secondary batteries using the lithium metal thin films according to Examples and Comparative Example as anodes and LiFePO₄ as cathodes were manufactured. The manufactured batteries were coin-type batteries (CR 2032) using the lithium metal thin films according to Examples and Comparative Example, glassy fiber filters were used as a separator, and a sulfur dioxide (SO₂)-based inorganic electrolyte solution (LiAlCl₄·3SO₂), in which the molar ratio of lithium chloride (LiCl) to aluminum chloride (AlCl₃) was 1:1, was used as an electrolyte.

### Test Example 1. Component Analysis of Inorganic Electrolyte Solutions

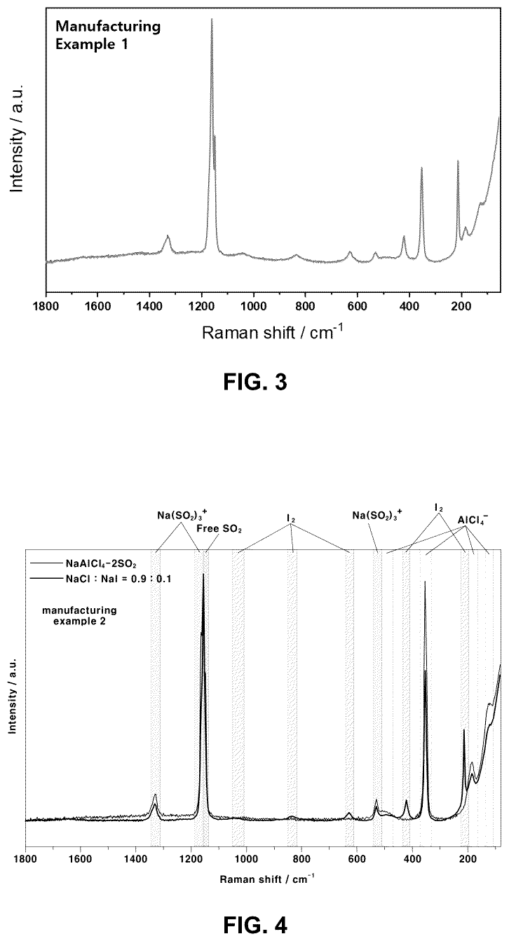

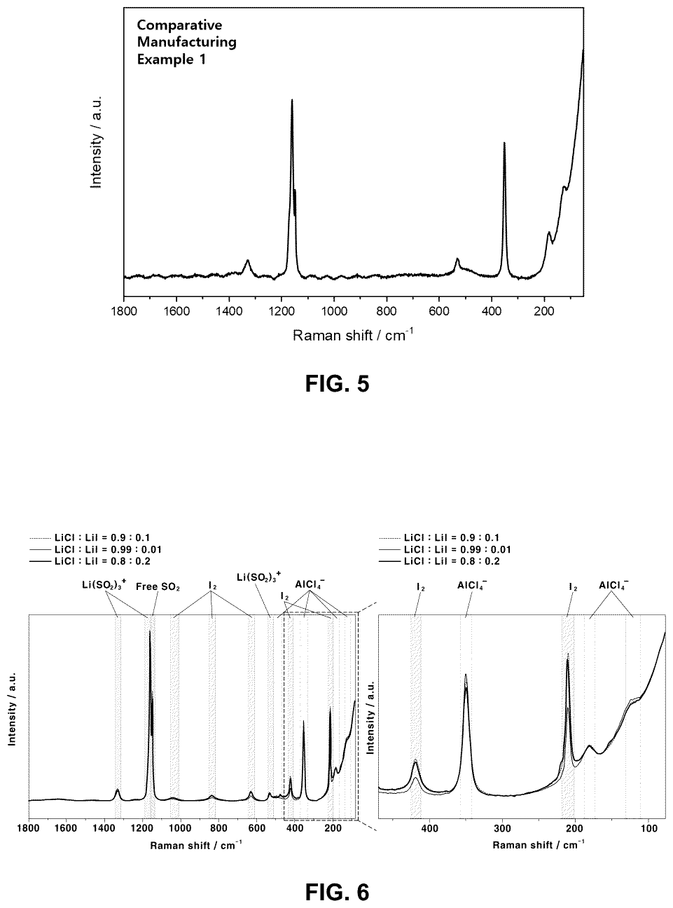

In order to confirm components of the inorganic electrolyte solutions manufactured according to Manufacturing Example 1 and Comparative Manufacturing Example 1, the inorganic electrolyte solutions manufactured according to Manufacturing Example 1 and Comparative Manufacturing Example 1 were analyzed using Raman spectroscopy. Results thereof are shown in FIGS. 3 and 5, respectively.

Referring to FIGS. 3 and 5, it was confirmed that new peaks were observed at about 207 cm⁻¹, 414 cm⁻¹, 621 cm⁻¹, and the like. Considering that the iodine compound is added in Manufacturing Example 1 unlike Comparative Manufacturing Example 1, it was confirmed that these peaks were due to iodine (I₂).

In order to confirm components of the inorganic electrolyte solutions manufactured according to Manufacturing Example 2 and Comparative Manufacturing Example 2, the inorganic electrolyte solutions manufactured according to Manufacturing Example 2 and Comparative Manufacturing Example 2 were analyzed using Raman spectroscopy. Results thereof are shown in FIG. 4.

Referring to FIG. 4, peaks at about 207 cm⁻¹, 414 cm⁻¹, and 621 cm⁻¹ were not observed in Comparative Manufacturing Example 2 (NaAlCl₄·2SO₂), but were observed in Manufacturing Example 2. Considering that the iodine compound is added in Manufacturing Example 2 unlike Comparative Manufacturing Example 2, it was confirmed that these peaks were due to iodine (I₂).

Meanwhile, in order to confirm the content of iodine varying in the inorganic electrolyte solution depending on the relative ratio of a metal chloride and an iodine compound added during synthesis of powder salt, inorganic electrolyte solutions were manufactured by varying the molar ratio of LiCl:LiI, as set forth in Table 2 below. The inorganic electrolyte solutions were analyzed using Raman spectroscopy, and results thereof are shown in FIG. 6.

TABLE 2

| LiCl | LiI | AlCl₃ |
|---|---|---|
| 0.9 | 0.1 | 1 |
| 0.99 | 0.01 | 1 |
| 0.8 | 0.2 | 1 |

Referring to FIG. 6, iodine peaks at about 207 cm⁻¹, 414 cm⁻¹, 621 cm⁻¹, and the like were observed in all molar ratios. Concretely, the intensities of peaks due to AlCl₄⁻ ions were confirmed as LiI (0.01)≥LiI (0.1)≥LiI (0.2), and the intensities of the iodine peaks were confirmed as LiI (0.1)≥LiI (0.2)≥LiI (0.01). Here, the intensities of the iodine peaks in the case of LiI (0.1) and LiI (0.2) were similar.

### Test Example 2. Electrochemical Evaluation

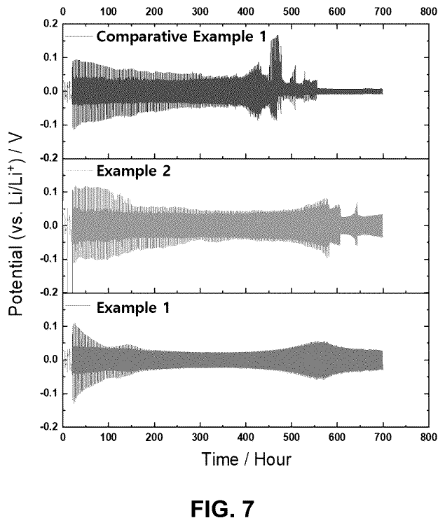

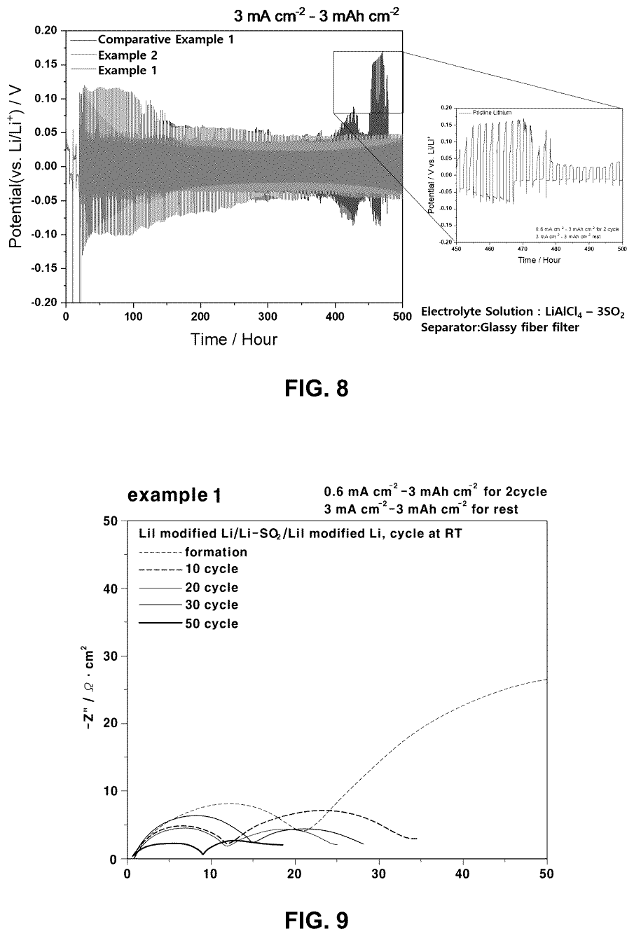

In order to evaluate performances of lithium metal impregnated with the inorganic electrolyte solutions according to Manufacturing Examples, electrochemical evaluation of the secondary batteries using the lithium metal thin films according to Examples 1 and 2 and Comparative Example 1 was conducted. Concretely, lithium symmetric cells were evaluated under the conditions of a current density of 3 mAcm⁻² and a capacity per area of 3 mAhcm⁻², and results thereof are shown in FIGS. 7 and 8. FIG. 8 shows the results shown in FIG. 7 in one graph.

Referring to FIGS. 7 and 8, it was confirmed that the secondary battery using the lithium metal thin film according to Example 1 shows lower overvoltage than the secondary batteries using the lithium metal thin films according to Example 2 and Comparative Example 1, and exhibited stable behavior even after about 700 hours (342 cycles).

The secondary battery using the lithium metal thin film according to Comparative Example 1, which did not go through the process of impregnating the lithium metal thin film in a sulfur dioxide-based inorganic electrolyte solution doped with iodine, showed a similar level of overvoltage to the secondary battery using the lithium metal thin film according to Example 2 up to 400 hours (212 cycles), but exhibited abnormal behavior due to micro-short circuit around about 460 hours (222 cycles).

When a secondary battery undergoes the formation process after assembling, an SEI layer may be formed on the surface of lithium metal. When the lithium secondary batteries using the lithium metal thin films according to Examples of the present disclosure are assembled, an SEI layer having high ionic conductivity may be formed due to the inorganic electrolyte layers formed on the surfaces of the lithium metal thin films. Thereby, the SEI layer may be uniformly formed on the charging and discharging process, high-rate characteristics may be improved, and growth of lithium dendrites may be suppressed.

Through FIGS. 7 and 8, it was confirmed that the secondary batteries using the lithium metal thin films according to Examples had lower and more stable overvoltage characteristics than the secondary battery using the lithium metal thin film according to Comparative Example when repeating charging and discharging of the secondary batteries at a high rate.

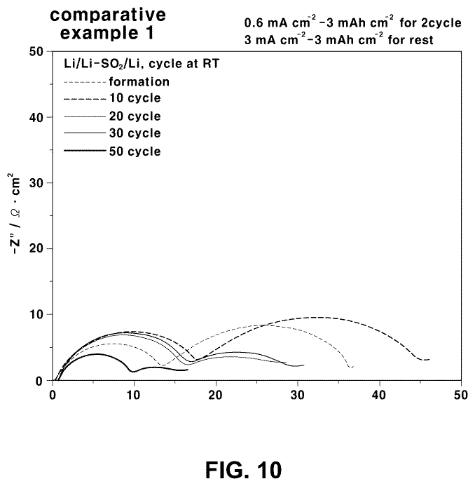

In order to find the causes of the overvoltage characteristics, impedances of the secondary batteries using the lithium metal thin films according to Example 1 and Comparative Example 1 were analyzed using electrochemical impedance spectroscopy (EIS) while increasing the number of repetitions of the charge and discharge cycle. Analysis results of the respective secondary batteries using electrochemical impedance spectroscopy (EIS) are shown in FIGS. 9 and 10, respectively, and specific result values are set forth in Table 3 below.

TABLE 3

| R_{SEI} / Ω | Example 1 | Comp. Example 1 |
|---|---|---|
| Formation cycle | 22.2 | 13.3 |
| After 10 cycle | 11.5 | 17.5 |
| After 20 cycle | 11.3 | 16.7 |
| After 30 cycle | 14.6 | 17.8 |
| After 50 cycle | 8.5 | 7.9 |

Referring to Table 3, the resistance R_{SEI} of the SEI layer of the secondary battery using the lithium metal thin film according to Example 1 was found to be greater than the resistance of the SEI layer of the secondary battery using the lithium metal thin film according to Comparative Example 1 immediately after the formation process, but the resistance R_{SEI} of the SEI layer of the secondary battery using the lithium metal thin film according to Example 1 was found to be smaller than the resistance of the SEI layer of the secondary battery the lithium metal thin film according to Comparative Example 1 after 10 charge and discharge cycles. It was confirmed that a decrease in overvoltage of the secondary battery using the lithium metal thin film according to Example 1 in the initial charge and discharge cycles was due to such a decrease in the resistance R_{SEI} of the SEI layer of the secondary battery using the lithium metal thin film according to Example 1.

### Test Example 3. Confirmation of SEI Layers Formed on Surfaces of Lithium Metal Thin Films after Charging and Discharging

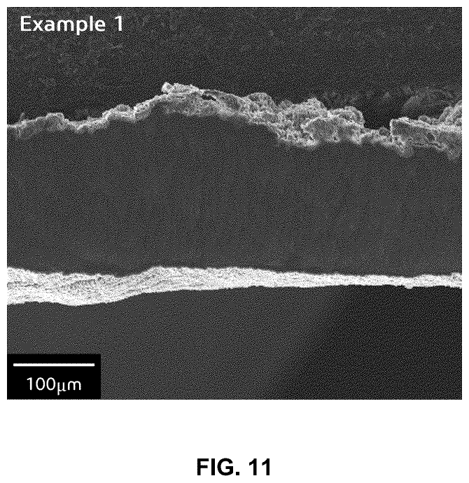

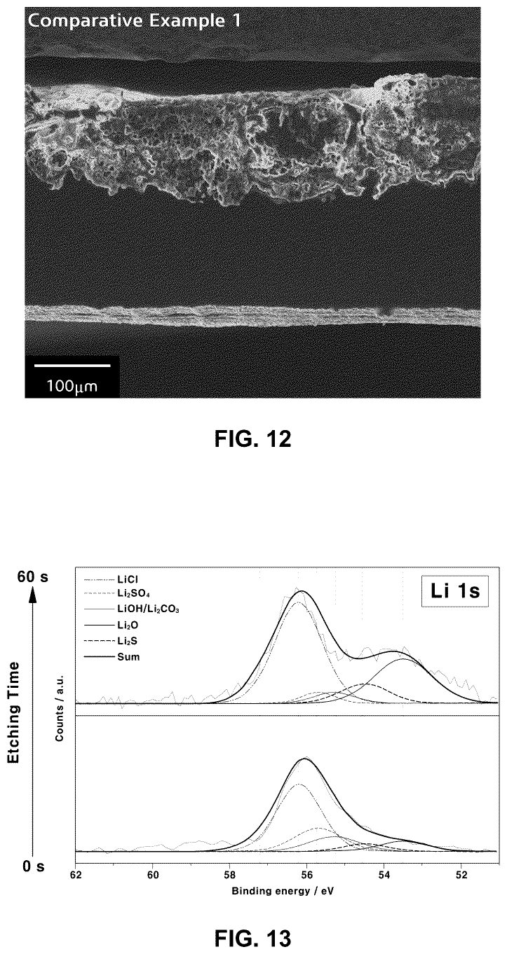

After 50 charge and discharge cycles of the secondary batteries manufactured according to Example 1 and Comparative Example 1, the cross sections of the lithium metal thin films of the respective secondary batteries were photographed with a scanning electron microscope (SEM) to confirm the SEI layers formed on the lithium metal thin films, and obtained images are shown in FIGS. 11 and 12, respectively.

Referring to FIG. 11, the thickness of non-cycled lithium metal was observed to be about 180 μm to 190 μm. Further, it was confirmed that the SEI layer formed on the lithium metal thin film was uniformly formed with a thickness of about 20 μm, and included porous Li.

Referring to FIG. 12, the thickness of non-cycled lithium metal was observed to be about 150 μm, and it was confirmed that the SEI layer formed on the lithium metal thin film was formed with a thickness of about 100 μm, and included porous Li.

Through Test Example 3, it can be confirmed that, when the secondary battery was manufactured using the lithium metal thin film according to Example 1, consumption of lithium metal due to charging and discharging was suppressed, and the SEI layer was formed more thinly and uniformly. Further, a separate inorganic electrolyte layer distinguished from the SEI layer was not observed. It is expected that the inorganic electrolyte layer served as a seed in the growth process of the SEI layer and the inorganic electrolyte layer and the SEI layer had substantially the same composition and were not distinguished from each other.

### Test Example 4. Component Analysis of Lithium Metal after Charging and Discharging

After 50 charge and discharge cycles of the secondary batteries manufactured according to Example 1 and Comparative Example 1, depth profiling using X-ray photoelectron spectroscopy (XPS) was conducted so as to detect the compositions of the lithium metal thin films and the SEI layers of the respective secondary batteries manufactured according to Example 1 and Comparative Example 1. Here, depth profiling was performed by etching at a rate of 18 nm/min using Ar⁺ for 60 seconds.

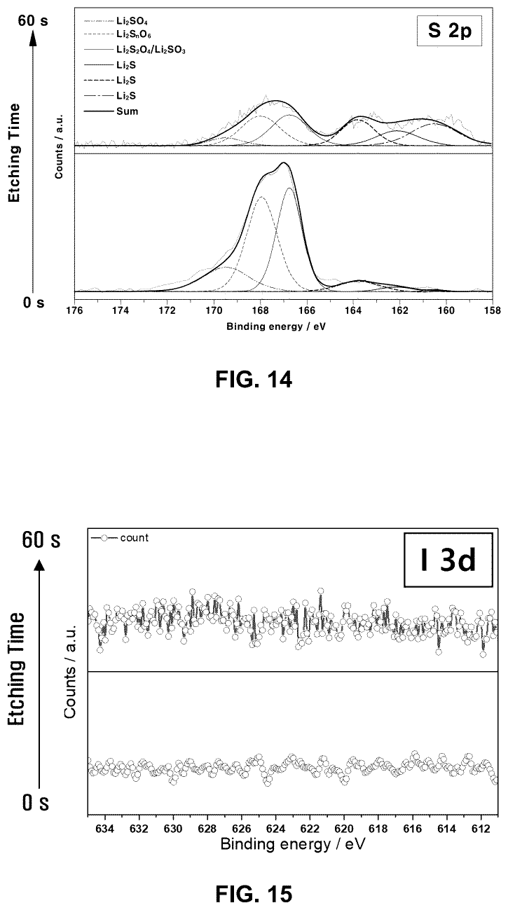

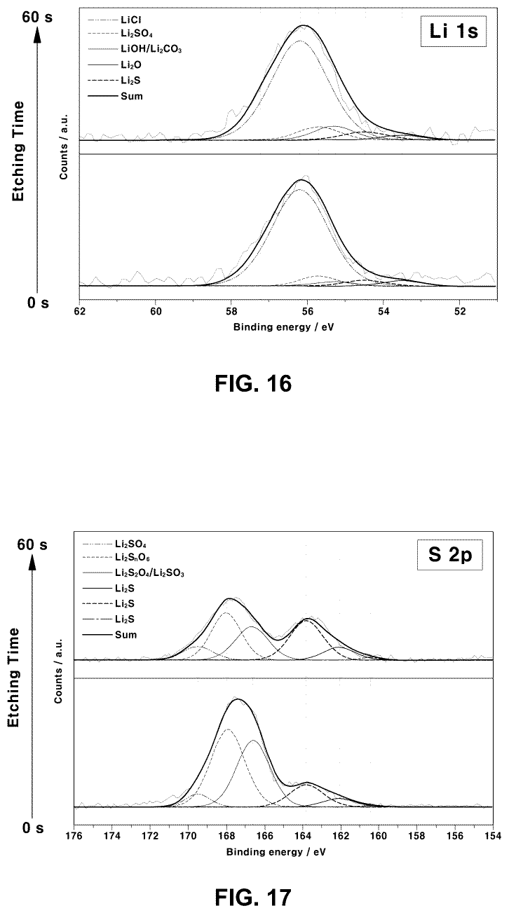

XPS depth profiling results of the secondary battery manufactured using the lithium metal thin film according to Example 1 are shown in FIGS. 13 to 15, and XPS depth profiling results of the secondary battery manufactured using the lithium metal thin film according to Comparative Example 1 are shown in FIGS. 16 and 17. Concretely, FIGS. 13 and 16 show XPS depth profiling results of Li 1s, FIGS. 14 and 17 show XPS depth profiling results of S 2p, and FIG. 15 shows XPS depth profiling results of I 3d.

Referring to FIGS. 13 and 14, the main components of the lithium metal thin film and the SEI layer formed on the lithium metal thin film according to Example 1 before depth profiling were LiCl and a lithium sulfur-oxy compound (LiₓS_{y}O_{z}).

As shown in FIG. 13, it may be confirmed that LiCl and Li₂O components were increased through increases in peak intensities at about 56.2 eV and 53.5 eV after depth profiling. Further, it may be predicted that, through the increase in the content of Li₂O having high mechanical strength after depth profiling, Li₂O included in the SEI layer reduced the thickness of the SEI layer and suppressed growth of lithium dendrites.

As shown in FIG. 14, it may be confirmed that a LiₓS_{y}O_{z} component was decreased through decreases in peak intensities at about 169.5 eV, 168 eV, and 166.8 eV after depth profiling, and a Li₂S component was increased through increases in peak intensities at about 160.5 eV, 162 eV, and 163.9 eV after depth profiling.

Particularly, it may be seen that the SEI layer having an increased content of Li₂S generally having high ionic conductivity was formed through an increase in the intensity of a peak band in the range of 158 eV to 162 eV. In this way, it may be seen that, when the lithium metal thin film according to Example 1 is used, the SEI layer having a high ionic conductivity is formed thereon and serves as a stable ion transfer medium at high current, thereby improving the high-rate characteristics of the secondary battery.

As shown in FIG. 15, it may be seen that iodine-related peaks were not observed in the lithium metal thin film and the SEI layer before and after depth profiling. Thereby, it was confirmed that iodine doped into the inorganic electrolyte solution serves to induce formation of the SEI layer having high ionic conductivity and was not directly included in the SEI layer.

In addition, referring to FIGS. 16 and 17, the main components of the lithium metal thin film and the SEI layer formed on the lithium metal thin film according to Comparative Example 1 before depth profiling were LiCl and a lithium sulfur-oxy compound (LiₓS_{y}O_{z}). However, it was confirmed that, in the case of the secondary battery using the lithium metal thin film according to Comparative Example 1, a difference in component changes depending on depth was not significant due to the SEI layer having a greater thickness than the SEI layer of the secondary battery 1 using the lithium metal thin film according to Example 1.

Particularly, unlike FIG. 14, in FIG. 17, peaks and increases in peak intensities in the range of 158 eV to 162 eV were hardly observed.

As is apparent from the above description, a sulfur dioxide-based inorganic electrolyte solution doped with an iodine compound according to the present disclosure has nonflammability and high ionic conductivity, and may be applied to secondary batteries so as to exhibit excellent electrochemical stability.

Particularly, the composition of an SEI layer formed in the formation process may be controlled by forming an inorganic electrolyte layer on the surface of lithium metal by impregnating the lithium metal with the inorganic electrolyte solution. Thereby, overvoltage occurring during charging and discharging of the secondary battery may be reduced and thus reliability and stability of the secondary battery may be improved, and growth of dendrites on the surface of the lithium metal may be suppressed.

The disclosure has been described in detail with reference to preferred embodiments thereof. However, it will be appreciated by those skilled in the art that changes may be made in these embodiments without departing from the principles and spirit of the disclosure, the scope of which is defined in the appended claims and their equivalents.

1. An inorganic electrolyte solution represented by Chemical Formula 1:
M·(AlCl₍₄₋ₓ₎Iₓ)_{z}·ySO₂,
wherein M is at least one selected from the group consisting of Li, Na, K, Ca, and Mg, 0<x≤1, 0<y≤6, and 1≤z≤2.

2. The inorganic electrolyte solution of claim 1, expressed as Li·(AlCl₍₄₋ₓ₎Iₓ)·ySO₂,
wherein 0<x≤1 and 0<y≤6.

3. The inorganic electrolyte solution of claim 1, expressed as Na·(AlCl₍₄₋ₓ₎Iₓ)·ySO₂,
wherein 0<x≤1 and 0<y≤6.

4. A method of manufacturing an inorganic electrolyte solution comprising:
preparing a powder salt by mixing a metal chloride, aluminum chloride and an iodine compound; and
synthesizing the inorganic electrolyte solution by injecting sulfur dioxide (SO₂) gas into the powder salt;
wherein the inorganic electrolyte solution is represented by Chemical Formula 1:
M·(AlCl₍₄₋ₓ₎Iₓ)_{z}·ySO₂,
wherein M is at least one selected from the group consisting of Li, Na, K, Ca, and Mg, 0<x≤1, 0<y≤6, and 1≤z≤2.

5. The method of claim 4, wherein the metal chloride comprises one selected from the group consisting of lithium chloride (LiCl), sodium chloride (NaCl), potassium chloride (KCl), calcium chloride (CaCl₂), magnesium chloride (MgCl₂), and combinations thereof.

6. The method of claim 4, wherein the iodine compound comprises one selected from the group consisting of lithium iodide (LiI), sodium iodide (NaI), potassium iodide (KI), calcium iodide (CaI₂), magnesium iodide (MgI₂), and combinations thereof.

7. The method of claim 4, wherein an amount of the iodine compound is 11 mol % or less with respect to an amount of the metal chloride.

8. The method of claim 4, wherein a metal comprised in the iodine compound and a metal comprised in the metal chloride are the same.

9. The method of claim 4, wherein the iodine compound and the metal chloride are mixed in a molar ratio of 1:3 to 1:100.

10. The method of claim 4, wherein the iodine compound and the metal chloride are mixed in a molar ratio of 1:8 to 1:10.

11. A method of manufacturing an anode for lithium secondary batteries comprising:
preparing an inorganic electrolyte solution represented by Chemical Formula 1: M·(AlCl₍₄₋ₓ₎Iₓ)_{z}·ySO₂; and
forming an inorganic electrolyte layer on lithium metal by impregnating the lithium metal with the inorganic electrolyte solution;
wherein M is at least one selected from the group consisting of Li, Na, K, Ca, and Mg, 0<x≤1, 0<y≤6, and 1≤z≤2.

12. The method of claim 11, wherein the inorganic electrolyte layer comprises one selected from the group consisting of LiCl, a lithium sulfur-oxy compound (LiₓS_{y}O_{z}), Li₂S, Li₂O, and combinations thereof.

13. An anode comprising:
a lithium metal; and
an inorganic electrolyte layer positioned on the lithium metal;
wherein the inorganic electrolyte layer comprises one selected from the group consisting of LiCl, a lithium sulfur-oxy compound (LiₓS_{y}O_{z}), Li₂S, Li₂O, and combinations thereof.

14. A lithium secondary battery comprising:
a cathode;
the anode according to claim 13;
a separator located between the cathode and the anode; and
an electrolyte impregnated into at least some of the cathode, the anode, or the separator;
wherein the anode further comprises a solid electrolyte interface (SEI) layer located on the inorganic electrolyte layer; and
the SEI layer is formed in a formation process.

15. The lithium secondary battery of claim 14, wherein the SEI layer does not comprise iodine (I).

16. The lithium secondary battery of claim 14, wherein, as depth profiling results obtained by XPS analysis of Li Is in the SEI layer, contents of lithium oxide (Li₂O) and lithium chloride (LiCl) are increased as a depth from a surface of the SEI layer towards the inorganic electrolyte layer increases.

17. The lithium secondary battery of claim 14, wherein, as depth profiling results obtained by XPS analysis of S 2p in the SEI layer, a content of lithium sulfide (Li₂S) is increased as a depth from a surface of the SEI layer towards the inorganic electrolyte layer increases.

18. The lithium secondary battery of claim 17, wherein peaks due to lithium sulfide (Li₂S) having the increased content are observed at a binding energy range of 158 eV to 162 eV.
